(19) United States
(12) Patent Application Publication
(10) Pub. No.: US 2016/0329673 A1
(43) Pub. Date: Nov. 10, 2016

(54) Surge Protected Extension Cord with Multiple Outlet Sections

(71) Applicant: James Doyle McCormick, Salt Lake City, UT (US)

(72) Inventor: James Doyle McCormick, Salt Lake City, UT (US)

(21) Appl. No.: 15/145,400

(22) Filed: May 3, 2016

Related U.S. Application Data
(60) Provisional application No. 62/157,073, filed on May 5, 2015.

(51) Int. Cl. H01R 27/02; H01R 25/00; H02J 9/06; H02H 9/00; H02J 4/00; G05F 3/02

(52) U.S. Cl. CPC H01R 27/02; H02J 4/00; G05F 3/02; H02J 9/06; H02H 9/005; H01R 25/003; H01R 25/006

(57) ABSTRACT

An adjustable length power strip that is designed to protect connected electrical devices from power surges. The apparatus is configured to resemble traditional power strips and extension cords. The apparatus includes a primary power strip an extension cord and a secondary power strip. The primary power strip is connected to an external power source and is used to distribute electrical power to the secondary power strip. The extension cord is situated between the primary power strip and the secondary power strip and electrically connects the two power strips. The secondary power strip enables a user to power connected electrical devices. Additionally, a user may connect multiple secondary power strips together in a chain. This is accomplished by connecting the extension cord of one secondary power strip to another secondary power strip.

The current application claims a priority to the U.S. Provisional Patent application Ser. No. 62/157,073 filed on May 5, 2015.

### FIELD OF THE INVENTION

The present invention relates generally to a surge protected power strip. More specifically, the present invention is a surge protected power strip with an extension cord of varying length attached to its housing.

### BACKGROUND OF THE INVENTION

Extension cords, outlet adapters, power strips and surge protectors are used among many individuals and can be found in most households today. These devices are commonly used to supply power to computer workstations, televisions, power tools and all things electronic. These devices are presently produced in a wide variety of sizes and some offer surge protection features as well. Most power strips have an elongated rectangular configuration with a row (or multiple) of outlets along the housing. These devices are generally designed to be set upon the floor behind a desk or television set. There are also plug-in adapters with multiple outlets designed to connect to a standard duplex wall outlet. In either case, all power cords must plug in at essentially a single location (i.e. the wall or power strip). This can sometimes present a challenge as some cords may be too short. This may lead to an individual needing to buy additional extension cords. Additionally, configurations such as these can also lead to conflicts between bulky plug-in stile transformers.

The present invention aims to solve the problems with the existing outlet options out on the market today. The present invention, known as the “EXTENDA SURGE”, has a unique surge protected extension cord design. The components of the surge protector, power switch and circuit breaker are all contained within its plug similar to the plug-in style surge protectors presently used. Instead of the outlet all being contained in a single strip-style housing, they are contained in multiple outlet assemblies linked via power cord segments. The plug or housing of the “EXTENDA SURGE” will have multiple outlets as well. Separating the outlet assemblies allows widely separated electronic devices and other loads to be easily connected to an outlet without the need for additional extension cords. By separating the connection points, conflicts between the bulky plug-in style transformers would be greatly minimized. This issue is further addressed by the outlets being arranged at right angles with respect to each other. In addition, the present invention can be produced in a variety of lengths with more or less outlet assemblies and could even potentially be produced with an uninterruptible power supply integrated within the plug.

### BRIEF DESCRIPTION OF THE DRAWINGS

FIG. 1 is a perspective view of the power bar.

FIG. 2 is a front view of the power bar.

FIG. 3 is a right-side view of the power bar.

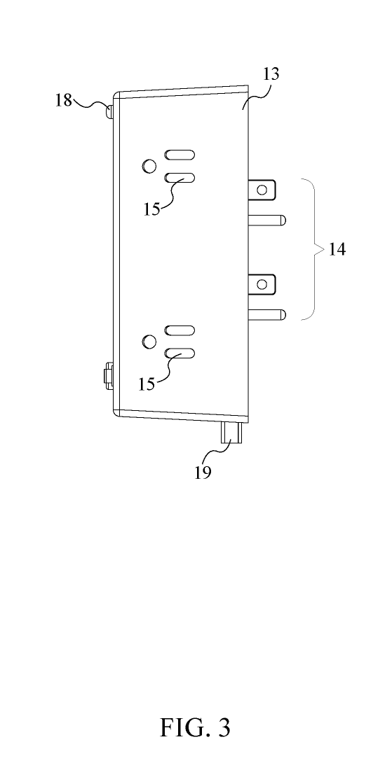

FIG. 4 is a front view of the extension block.

FIG. 5 is a perspective view of the extension block.

FIG. 6 is a perspective view of the present invention. In this view at least one subsequent extension block is connected to an initial extension block, which is in turn connected to the power bar.

FIG. 7 is a diagram illustrating the electrical connections between the components of the present invention.

### DETAIL DESCRIPTIONS OF THE INVENTION

All illustrations of the drawings are for the purpose of describing selected versions of the present invention and are not intended to limit the scope of the present invention.

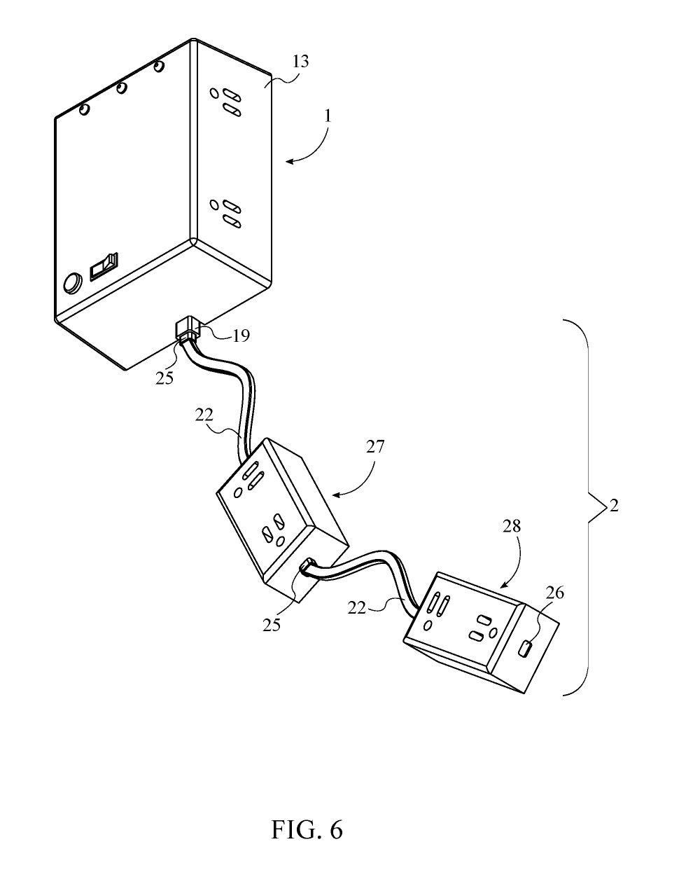

The present invention is a reconfigurable power extension device for distributing power to electrical devices. In its preferred embodiment, the present invention is a surge protector power strip whose length and number of available electrical outlets can be modified by a user. In reference to FIG. 6, the present invention comprises a power bar 1 and at least one extension block 2. The power bar 1 is an electrical module that plugs into an external power source and functions as a hub to condition the electrical power that is distributed to the at least one extension block 2. The at least one extension block 2 functions as a power strip with multiple electrical outlets and is capable of connecting to the power bar 1. In its preferred configuration, a user of the present invention connects the power bar 1 to an external power source. The user then connects the at least one extension block 2 to the power bar 1. In the event that the at least one extension block 2 is a plurality of extension blocks 2, the user is able to serially connect each of the plurality of extension blocks 2 to the power bar 1. More specifically, each succeeding extension block 2 is serially connected to each preceding extension block 2 so that the plurality of extension blocks 2 can be electrically connected to the power bar 1.

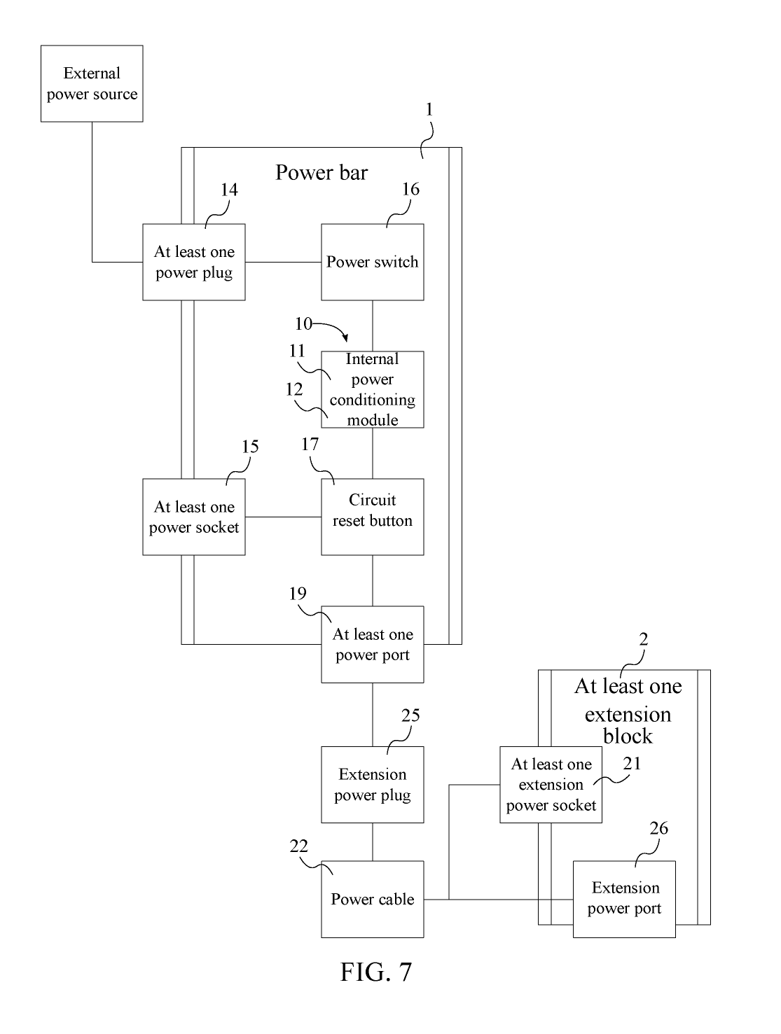

The general configuration of the aforementioned components enables the present invention to effectively distribute electrical power to connected electrical devices. In reference to FIG. 6 and FIG. 7, the power bar 1 comprises an internal power conditioning module 10, a housing 13, at least one power plug 14, and at least one power port 19. The internal power conditioning module 10 is mounted within the housing 13 so that electrical power moving through the power bar 1 does not exceed desired thresholds. The housing 13 delineates the overall shape of the power bar 1 and functions as the main structural base of the power bar 1 to position and secure other sub-components of the power bar 1. The at least one power plug 14 is integrated into the housing 13 so that the power bar 1 can be electrically connected to an external power source through the at least one power plug 14. The at least one power plug 14 is positioned to facilitate connecting the power bar 1 to commercially available electrical outlets. Similarly, the at least one power port 19 is integrated into the housing 13 so that the at least one extension block 2 can be electrically connected to the power bar 1. Additionally, the at least one power plug 14 and the at least one power port 19 are electrically connected to the internal power conditioning module 10. As a result, electrical power delivered to the at least one power plug 14 is transferred to the at least one power port 19, through the internal power conditioning module 10.

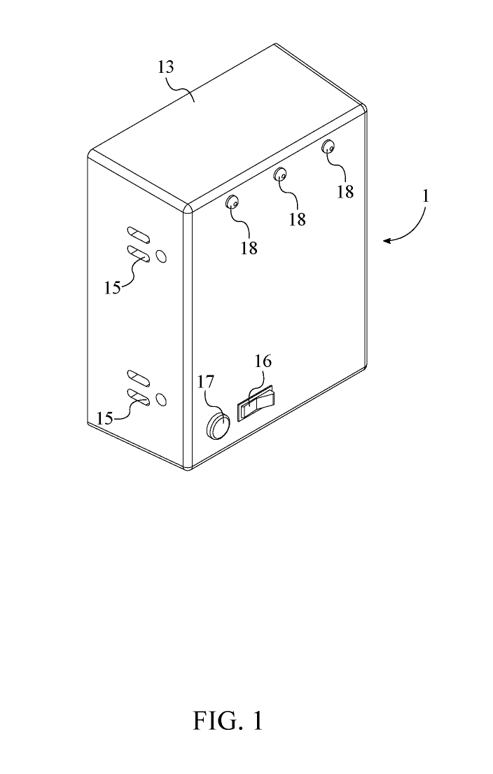

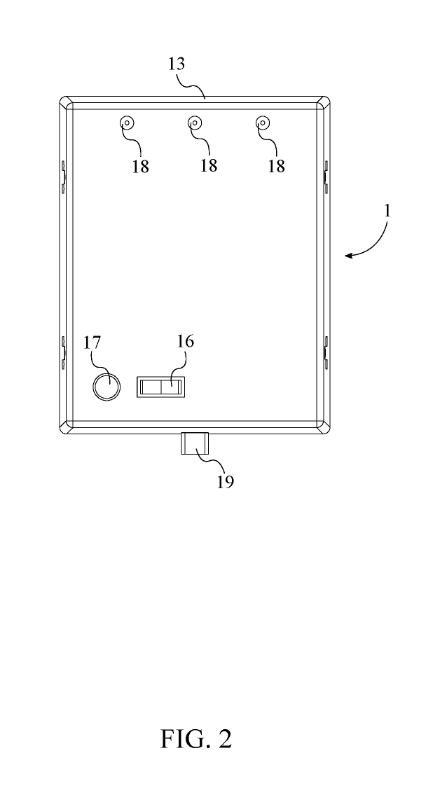

In some embodiments of the present invention, the power bar 1 further comprises a power switch 16 that is used to govern the flow of electrical current to the internal power conditioning module 10. In reference to FIG. 1, FIG. 2 and FIG. 6, the power switch 16 is integrated into the housing 13 so that a user can selectively manipulate the power switch 16 between an on-configuration and an off-configuration. In addition, the power switch 16 is electrically coupled to the internal power conditioning module 10. As a result, the power switch 16 prohibits the flow of current from the at least one power plug 14 to the internal power conditioning module 10, while in the off-configuration. Conversely, the power switch 16 permits the flow of electrical current from the at least one power plug 14 to the internal power conditioning module 10, while in the on-configuration.

In some embodiments of the present invention, the power bar 1 further comprises a circuit reset button 17 that is used to activate the internal power conditioning module 10. In reference to FIG. 1, FIG. 2 and FIG. 6, the circuit reset button 17 is integrated into the housing 13 so that a user can selectively manipulate the circuit reset button 17 between an opened-configuration and a closed-configuration. In addition, the circuit reset button 17 is electrically connected to the internal power conditioning module 10. As a result, the circuit reset button 17 opens the circuit between the internal power conditioning module 10 and the electronic components of the power bar 1, while in the opened-configuration. Conversely, the circuit reset button 17 closes the circuit between the internal power conditioning module 10 and the electronic components of the power bar 1, while in the closed-configuration. In the opened-configuration, the circuit reset button 17 extends away from the housing 13. The circuit reset button 17 remains in the opened-configuration until an applied external force moves the circuit reset button 17 into the closed-configuration. The circuit reset button 17 is automatically moved into the opened-configuration when the current flowing through the internal power conditioning module 10 exceeds a specified threshold.

In the preferred embodiment of the present invention the power bar 1 further comprises at least one power socket 15 that enables external electrical devices to be electrically mounted to the power bar 1, as shown in FIG. 1. The at least one power socket 15 is integrated into the housing 13 so that a user is able to plug an electrical device into the at least one power socket 15. In addition, the at least one power socket 15 is electrically to the internal power conditioning module 10. In this way, the electrical power delivered to the at least one power plug 14 is able to be transferred to the at least one power socket 15 to power a connected electrical device.

In the preferred embodiment of the present invention, the power bar 1 further comprises at least one visual indicator 18 that are used to visually output the state of the internal power conditioning module 10, as shown in FIG. 1. The at least one visual indicator 18 is integrated into the housing 13 so that the at least one visual indicator 18 is maintained in an orientation which facilitates user evaluation. The at least one visual indicator 18 is electrically connected to the internal power conditioning module 10 so that the changes in the state of the internal power conditioning module 10 are reflected by the visual output of the at least one visual indicator 18.

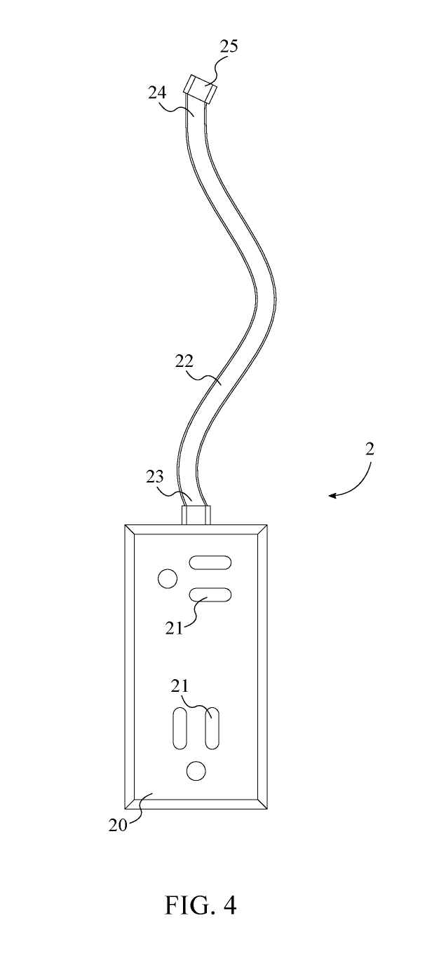

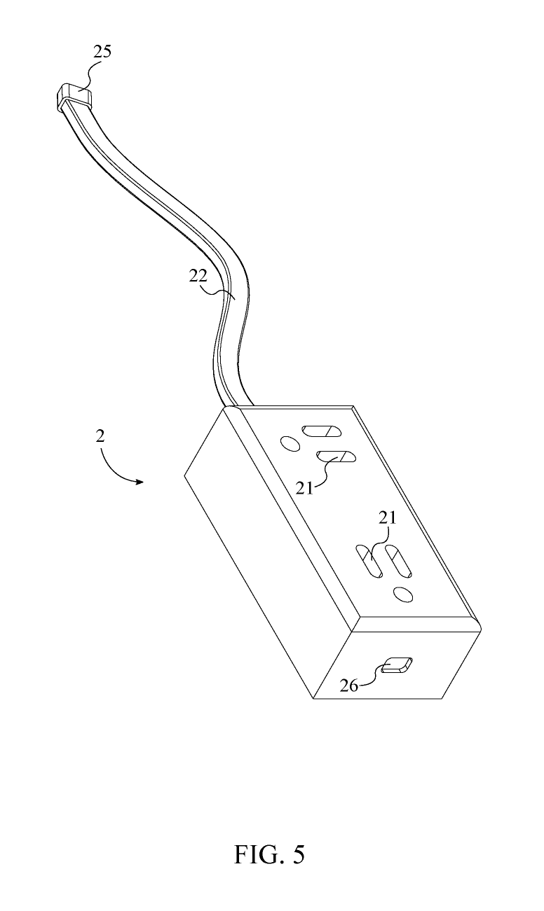

In reference to FIG. 4 and FIG. 5, the at least one extension block 2 is a power strip that electrically connects to the power bar 1, and to which external electrical devices can be electrically connected. In addition, the at least one extension block 2 comprises a casing 20, at least one extension power socket 21, a power cable 22, an extension power plug 25, and an extension power port 26. The casing 20 delineates the overall shape of the at least one extension block 2 and functions as the structural base of the at least one extension block 2 to position and secure other sub-components of at least one extension block 2. The at least one extension power socket 21 is integrated into the casing 20 so that an external electrical device may be electrically mounted to the at least one extension block 2 The term electrically mounted is used herein to refer to detachably connected interlocking interfaces which become electrically connected while engaged. The at least one extension power socket 21 may be a USB port or other electrical interface known by those in the art. The power cable comprises a first end 23 and a second end 24. The first end 23 of the power cable 22 is adjacently connected to the casing 20 so that power cable 22 is able to deliver electrical power from an external power source into the at least one extension block 2. The extension power plug 25 is adjacently connected to the second end 24 of the power cable 22, opposite the casing 20. As a result, the power plug is able to become electrically mounted to the at least one power port 19. In reference to FIG. 7, the at least one extension power socket 21 and the extension power port 26 are electrically connected to the extension power plug 25 through the power cable 22. As a result, electrical power within the at least one extension block 2 can be distributed to the at least one extension power socket 21 and the extension power port 26. The extension power port 26 is integrated into the casing 20 so that the extension power plug 25 of the succeeding extension block 2 can be electrically mounted to the at least one extension block 2

In the preferred embodiment of the present invention as shown in FIG. 7, the internal power conditioning module 10 comprises a surge protection module 11 that prevents spikes in electrical current from damaging the electrical devices connected to the at least one power socket 15 and the at least one power port 19. In this embodiment, the at least one power plug 14, the at least one power socket 15, and the at least one power port 19 are electrically connected to the surge protection module 11. As a result, electrical power is delivered from the at least one power plug 14, to the at least one power socket 15 and the at least one power port 19, through the surge protection module 11.

In a separate embodiment of the present invention as shown in FIG. 7, the internal power conditioning module 10 comprises an uninterruptible power supply 12 that prevents spikes in electrical current from damaging the electrical devices connected to the at least one power socket 15 and the at least one power port 19. In addition, the uninterruptible power supply 12 is equipped with an internal rechargeable battery that provides emergency power the at least one power socket 15 and at least one power port 19, in the event of external power supply failure. In this embodiment, the at least one power plug 14, the at least one power socket 15, and the at least one power port 19 are electrically connected to the uninterruptible power supply 12. As a result, electrical power is delivered from the at least one power plug 14, to the at least one power socket 15 and the at least one power port 19, through the uninterruptible power supply 12.

In an alternative configuration of the present invention as shown in FIG. 6, the at least one extension block 2 further comprises an initial extension block 27 and at least one subsequent extension block 28. The extension power plug 25 of the initial extension block 27 is electrically mounted to the at least one power port 19 so that electrical power can be delivered to the initial extension block 27. The extension power plug 25 of the at least one subsequent extension block 28 is electrically mounted to the extension power port 26 of the initial extension block 27 so that electrical power can be transferred from the power bar 1 to the at least one subsequent extension block 28, through the initial extension block 27. In this way, a user is able to electrically mount the at least one subsequent extension block 28 expanding the number of at least one extension power socket 21.

Although the invention has been explained in relation to its preferred embodiment, it is to be understood that many other possible modifications and variations can be made without departing from the spirit and scope of the invention as hereinafter claimed.

What is claimed is:

1. a power extension device for distributing power to electrical devices comprises:
a power bar;
at least one extension block;
the power bar comprises an internal power conditioning module, a housing, at least one power plug, and at least one power port;
the at least one extension block comprises a casing, at least one extension power socket, a power cable, an extension power plug, and an extension power port;
the at least one power plug and the at least one power port being integrated into the housing;
the at least one power plug and the at least one power port being electrically connected to the internal power conditioning module;
the at least one secondary power socket and the secondary power port being integrated into the casing;
a first end of the power cable being adjacently connected to the casing;
the extension power plug being adjacently connected to a second end of the power cable, opposite the casing;
the at least one extension power socket and the extension power port being electrically connected to the extension power plug through the power cable; and
the extension power plug being electrically mounted to the power port.

2. The power extension device for distributing power to electrical devices as claimed in claim 1 comprises:
a power switch;
the power switch being integrated into the housing; and
the power switch being electrically coupled to the at least one power plug and the internal power conditioning module, wherein the power switch is used to govern the flow of current to the internal power conditioning module.

3. The power extension device for distributing power to electrical devices as claimed in claim 1 comprises:
a circuit reset button;
the circuit reset button being integrated into the housing; and
the circuit reset button being electrically connected to the internal power conditioning module, wherein the circuit reset switch is used to activate the internal power conditioning module.

4. The power extension device for distributing power to electrical devices as claimed in claim 1 comprises:
at least one power socket;
the at least one power socket being integrated into the housing; and
the at least one power socket being electrically connected to the internal power conditioning module.

5. The power extension device for distributing power to electrical devices as claimed in claim 1 comprises:
at least one visual indicator;
the at least one visual indicator being integrated into the housing; and
the at least one visual indicator being electrically connected to the internal power conditioning module.

6. The power extension device for distributing power to electrical devices as claimed in claim 1 comprises:
at least one power sockets;
the internal power conditioning module comprises a surge protection module; and
the at least one power socket and the at least one power port being electrically connected to the surge protection module.

7. The power extension device for distributing power to electrical devices as claimed in claim 1 comprises:
at least one power sockets;
the internal power conditioning module comprises an uninterruptible power supply; and
the at least one power socket and the at least one power port being electrically connected to the uninterruptible power supply.

8. The power extension device for distributing power to electrical devices as claimed in claim 1 comprises:
the at least one extension block further comprises an initial extension block and at least one subsequent extension block;
the extension power plug of the initial extension block being electrically connected with the at least one power port; and
the extension power plug of the at least one subsequent extension block being electrically connected with an extension power port of the initial extension block.

9. a power extension device for distributing power to electrical devices comprises:
a power bar;
at least one extension block;
the power bar comprises an internal power conditioning module, a housing, at least one power plug, at least one power socket, and at least one power port;
the at least one extension block comprises a casing, at least one extension power socket, a power cable, an extension power plug, and an extension power port;
the internal power conditioning module comprises a surge protection module;
the at least one power plug, at least one power socket, and the at least one power port being integrated into the housing;
the at least one power plug, at least one power socket, and the at least one power port being electrically connected to the internal power conditioning module;
the at least one secondary power socket and the secondary power port being integrated into the casing;
a first end of the power cable being adjacently connected to the casing;
the extension power plug being adjacently connected to a second end of the power cable, opposite the casing;
the at least one extension power socket and the extension power port being electrically connected to the extension power plug through the power cable; and
the extension power plug being electrically mounted to the power port.

10. The power extension device for distributing power to electrical devices as claimed in claim 9 comprises:
a power switch;
the power switch being integrated into the housing; and
the power switch being electrically coupled to the at least one power plug and the internal power conditioning module, wherein the power switch is used to govern the flow of current to the internal power conditioning module.

11. The power extension device for distributing power to electrical devices as claimed in claim 9 comprises:
a circuit reset button;
the circuit reset button being integrated into the housing; and
the circuit reset button being electrically connected to the internal power conditioning module, wherein the circuit reset switch is used to activate the internal power conditioning module.

12. The power extension device for distributing power to electrical devices as claimed in claim 9 comprises:
at least one visual indicator;
the at least one visual indicator being integrated into the housing; and
the at least one visual indicator being electrically connected to the internal power conditioning module.

13. The power extension device for distributing power to electrical devices as claimed in claim 9 comprises:
the at least one extension block further comprises an initial extension block and at least one subsequent extension block;
the extension power plug of the initial extension block being electrically connected with the at least one power port; and
the extension power plug of the at least one subsequent extension block being electrically connected with an extension power port of the initial extension block.

14. a power extension device for distributing power to electrical devices comprises:
a power bar;
at least one extension block;
the power bar comprises an internal power conditioning module, a housing, at least one power plug, at least one power socket, and at least one power port;
the at least one extension block comprises a casing, at least one extension power socket, a power cable, an extension power plug, and an extension power port;
the internal power conditioning module comprises an uninterruptable power supply;
the at least one power plug, at least one power socket, and the at least one power port being integrated into the housing;
the at least one power plug, at least one power socket, and the at least one power port being electrically connected to the internal power conditioning module;
the at least one secondary power socket and the secondary power port being integrated into the casing;
a first end of the power cable being adjacently connected to the casing;
the extension power plug being adjacently connected to a second end of the power cable, opposite the casing;
the at least one extension power socket and the extension power port being electrically connected to the extension power plug through the power cable; and
the extension power plug being electrically mounted to the power port.

15. The power extension device for distributing power to electrical devices as claimed in claim 14 comprises:
a power switch;
the power switch being integrated into the housing; and
the power switch being electrically coupled to the at least one power plug and the internal power conditioning module, wherein the power switch is used to govern the flow of current to the internal power conditioning module.

16. The power extension device for distributing power to electrical devices as claimed in claim 14 comprises:
a circuit reset button;
the circuit reset button being integrated into the housing; and
the circuit reset button being electrically connected to the internal power conditioning module, wherein the circuit reset switch is used to activate the internal power conditioning module.

17. The power extension device for distributing power to electrical devices as claimed in claim 14 comprises:
at least one visual indicator;
the at least one visual indicator being integrated into the housing; and
the at least one visual indicator being electrically connected to the internal power conditioning module.

18. The power extension device for distributing power to electrical devices as claimed in claim 14 comprises:
the at least one extension block further comprises an initial extension block and at least one subsequent extension block;
the extension power plug of the initial extension block being electrically connected with the at least one power port; and
the extension power plug of the at least one subsequent extension block being electrically connected with an extension power port of the initial extension block.
